(19) United States
(12) Patent Application Publication
(10) Pub. No.: US 2012/0194496 A1
(43) Pub. Date: Aug. 2, 2012

(54) APPARATUS AND METHOD FOR SUPPORTING A MECHANICAL LAYER

(75) Inventors: Fan Zhong, Fremont, CA (US); David Heald, Solvang, CA (US); Wenyu Sun, Longtan (TW); Chuan Pu, Foster City, CA (US); Chandra Tupelly, San Ramon, CA (US)

(73) Assignee: QUALCOMM MEMS Technologies, Inc., San Diego, CA (US)

(21) Appl. No.: 13/019,159

(22) Filed: Feb. 1, 2011

(51) Int. Cl. G06F 3/038; G02B 26/00; H02N 11/00; B05D 5/12; C03C 15/00

(52) U.S. Cl. 345/211; 427/58; 216/17; 310/300; 359/290

(57) ABSTRACT

This disclosure provides systems, methods and apparatuses for supporting a mechanical layer. In one aspect, an electromechanical systems device includes a substrate, a mechanical layer, and a post positioned on the substrate for supporting the mechanical layer. The mechanical layer is spaced from the substrate and defines one side of a gap between the mechanical layer and the substrate, and the mechanical layer is movable in the gap between an actuated position and a relaxed position. The post includes a wing portion in contact with a portion of the mechanical layer, the wing portion positioned between the gap and the mechanical layer. The wing portion can include a plurality of layers configured to control the curvature of the mechanical layer.

### TECHNICAL FIELD

This disclosure relates to electromechanical systems.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

During manufacture of interferometric devices, a sacrificial layer can be used to determine a gap height between the reflective membrane and the stationary layer. However, upon removal of the sacrificial layer and launch of the reflective membrane, mechanical stresses can cause the reflective membrane to be spaced from the stationary layer by a distance different than the sacrificial layer thickness. There is a need for interferometric devices having improved launch control.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical systems device including a substrate, a mechanical layer, and a post. The mechanical layer is positioned over the substrate and is spaced from the substrate and defines one side of a gap between the mechanical layer and the substrate. The mechanical layer is movable in the gap between an actuated position and a relaxed position. The post is positioned on the substrate and supports the mechanical layer, and the post includes a wing portion in contact with a portion of the mechanical layer. The wing portion is positioned between a portion of the gap and the mechanical layer, and includes a plurality of layers configured to control the curvature of the mechanical layer.

In some implementations, the plurality of layers includes a first layer, a second layer, and a third layer, the second layer disposed between the first and third layers.

In some implementations, the first layer, the second layer and the third layer have a first thickness, a second thickness, and a third thickness, respectively, and the first, second and third thicknesses are selected so as to control the curvature of the mechanical layer.

According to some implementations, the first layer, second layer and third layer are configured to have a first stress, a second stress and a third stress, respectively, and the stresses of the first, second, and third layers are selected so as to control the curvature of the mechanical layer. Additionally, the stresses of the first and third layers can be compressive, and the stress of the second layer can be tensile.

In various implementations, at least a portion of the first layer is disposed between the second layer and the gap, and the first layer is resistant to the etchant of the sacrificial layer. The first layer and third layers can include SiO₂ and the second layer can include SiON.

Another implementation is a method of controlling the curvature of a mechanical layer in an electromechanical systems device, the mechanical layer having an actuated position and a relaxed position. The method includes selecting one or more of a thickness characteristic, a composition characteristic, and a stress characteristic for each of a plurality of layers of a support post. The method further includes depositing support layers over a substrate, the support layers including the plurality of layers, the plurality of layers including the one or more selected thickness, composition, and stress characteristics. The method further includes forming a support post from the plurality of support layers, the support post comprising a wing portion, and forming a mechanical layer spaced from the substrate and defining one side of a gap. The mechanical layer is formed over the wing portion of the support post and in contact with the wing portion, and the mechanical layer is formed to be movable between the actuated position and the relaxed position. A curvature of the mechanical layer when in the relaxed position is controlled by the selected one or more thickness, composition, and stress characteristics of the plurality of layers.

In some implementations, deflection of the wing portion relative to the substrate is controlled by the selected one or more thickness, composition, and stress characteristics. The wing portion can overlap the sacrificial layer, and the curvature of the mechanical layer when in the relaxed position can be further controlled by an overlap of the wing portion and the sacrificial layer.

Another implementation is an electromechanical systems device including a substrate, a mechanical layer, and means for supporting the mechanical layer. The mechanical layer is positioned over the substrate, and is spaced from the substrate and defines one side of a gap between the mechanical layer and the substrate. The mechanical layer is movable in the gap between an actuated position and a relaxed position. The means for supporting the mechanical layer positioned on the substrate, and includes a means for directing a curvature of the mechanical layer. The curvature correcting means is in contact with a portion of the mechanical layer and is positioned between a portion of the gap and the mechanical layer. The curvature directing means includes a plurality of layers configured to direct the curvature of the mechanical layer.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of a flow diagram illustrating a manufacturing process for an interferometric modulator.

FIGS. 10A-10I show examples of cross-sectional schematic illustrations of various stages in a method of making manufacturing processes for interferometric modulators according to various implementations.

FIG. 11 shows an example of a flow diagram illustrating a method of controlling the curvature of a mechanical layer.

FIGS. 12A and 12B show examples of system block diagrams illustrating a display device that includes a plurality of interferometric modulators.

Like reference numbers and designations in the various drawings indicate like elements, which may have certain structural or characteristic differences according to certain implementations.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to a person having ordinary skill in the art.

Electromechanical devices having a multi-layer support post are disclosed. The multi-layer support post can include a multi-layer wing, or flange, for supporting the mechanical layer over the substrate to define a gap. The launch of the mechanical layer can be controlled by selecting certain features of the multi-layer wing, for example, the number of layers, the materials, thicknesses, stresses and/or geometries of the layers of the multi-layer wing. Through certain design selections of the multi-layer wing, the launch and curvature of the mechanical layer can be controlled, which can lead to an improvement in contrast ratio, gamut, and color saturation of a display including such devices.

Particular implementations of the subject matter described in this disclosure can be implemented to control the curvature and/or shape of the mechanical layer after removal of a sacrificial layer. Additionally, some implementations can reduce stiction between the mechanical layer and the substrate and/or protect the post from sacrificial release chemistry. Furthermore, according to a number of implementations, optical properties of the display can be improved including, for example, an improvement in the dark state, contrast ratio, gamut, and/or color saturation.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

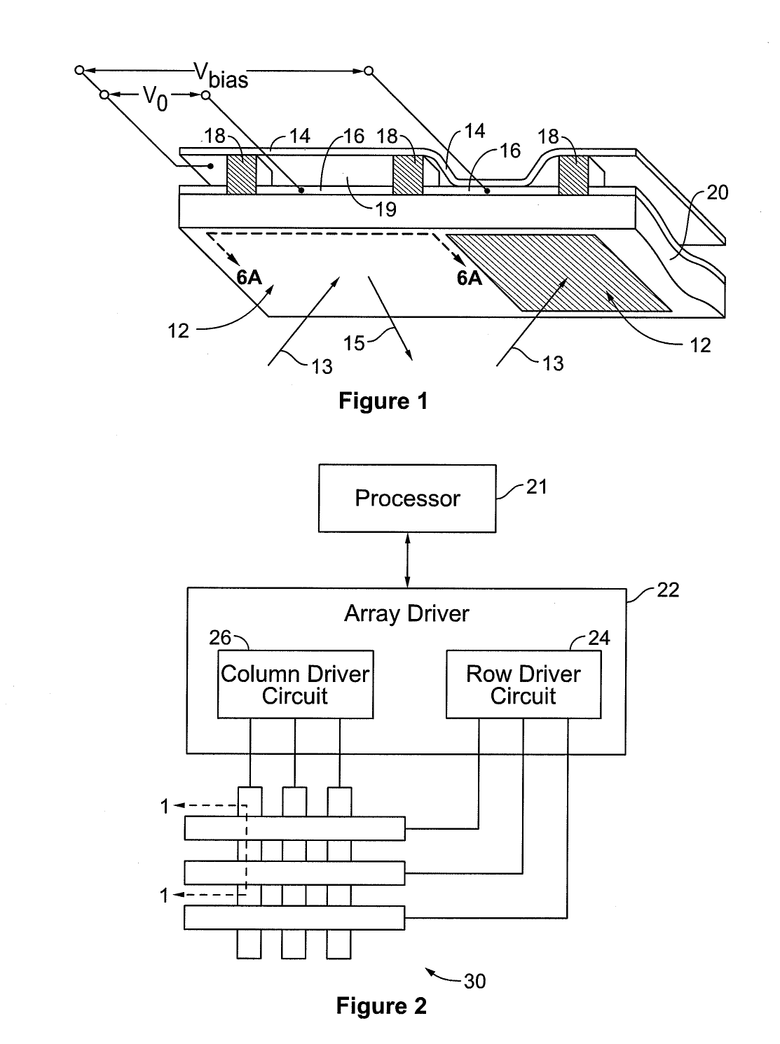

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be approximately 1-1000 um, while the gap 19 may be on the order of 1000-10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

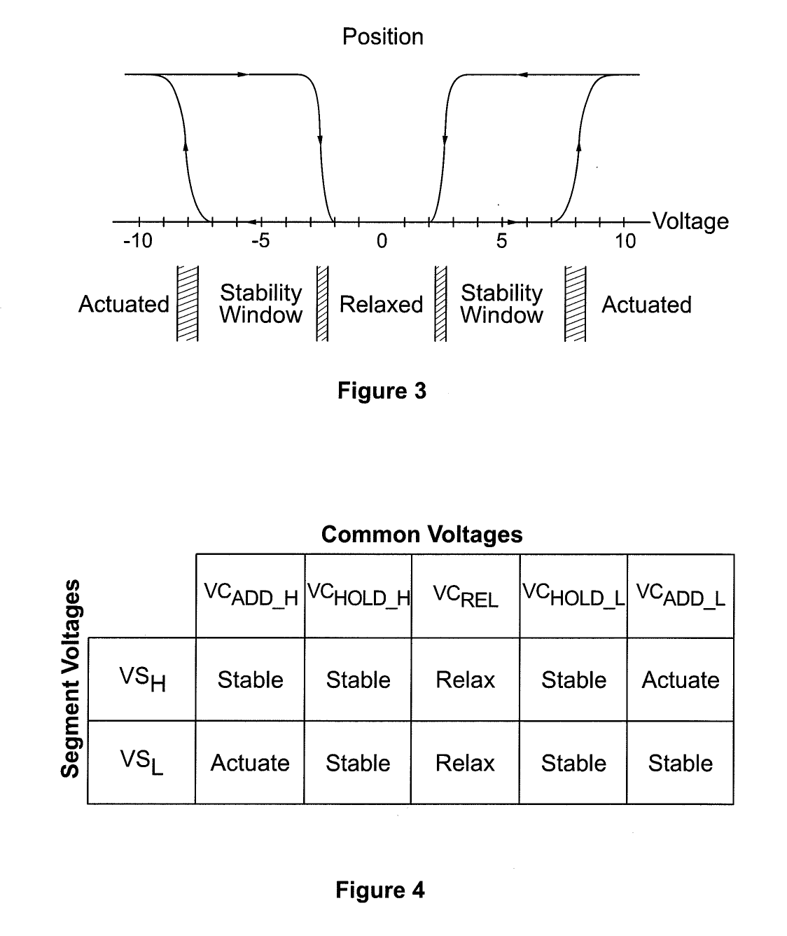

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

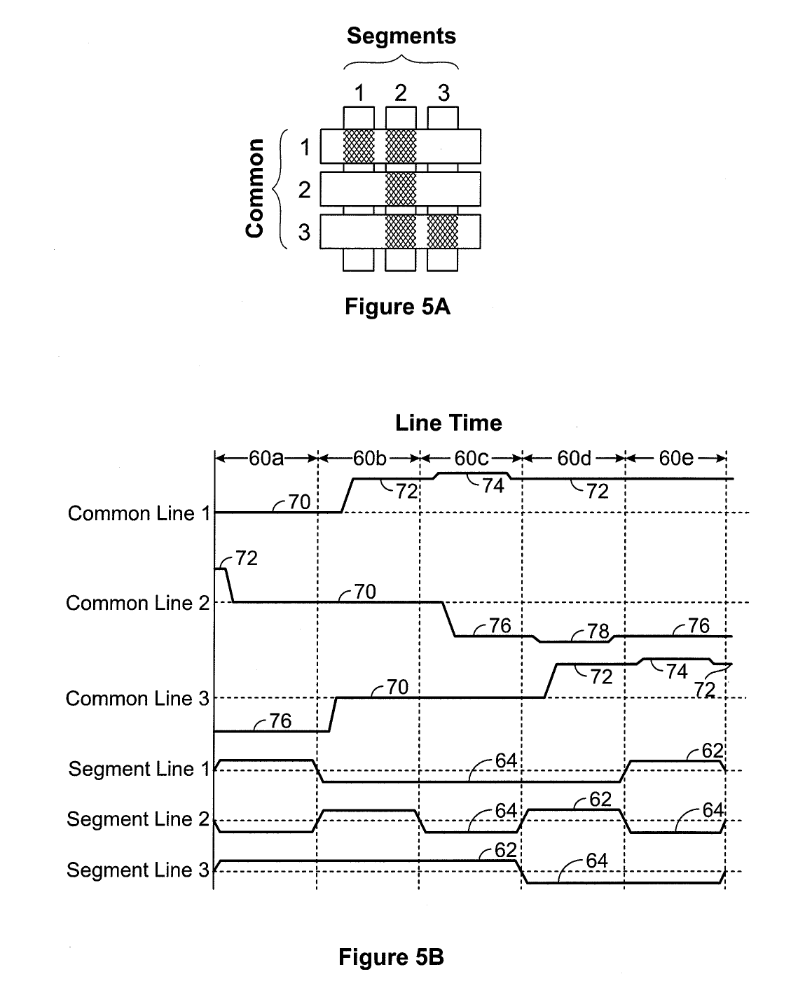

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{H}} or a low hold voltage VC_{HOLD}_{_{L}}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{H}} or a low addressing voltage VC_{ADD}_{_{L}}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{H}} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{L}} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{L}}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

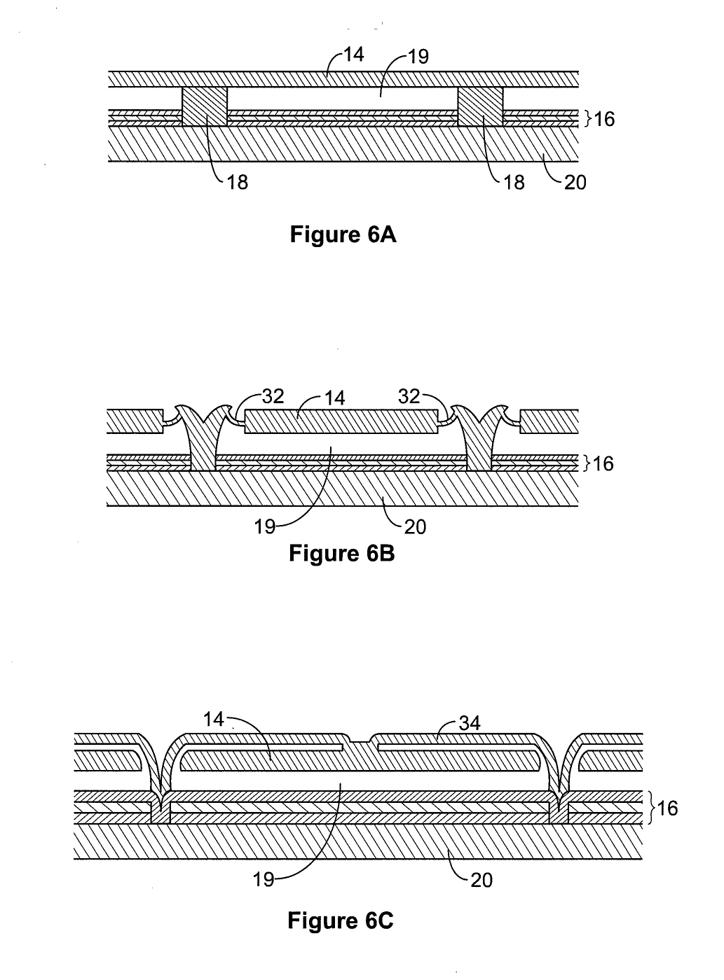

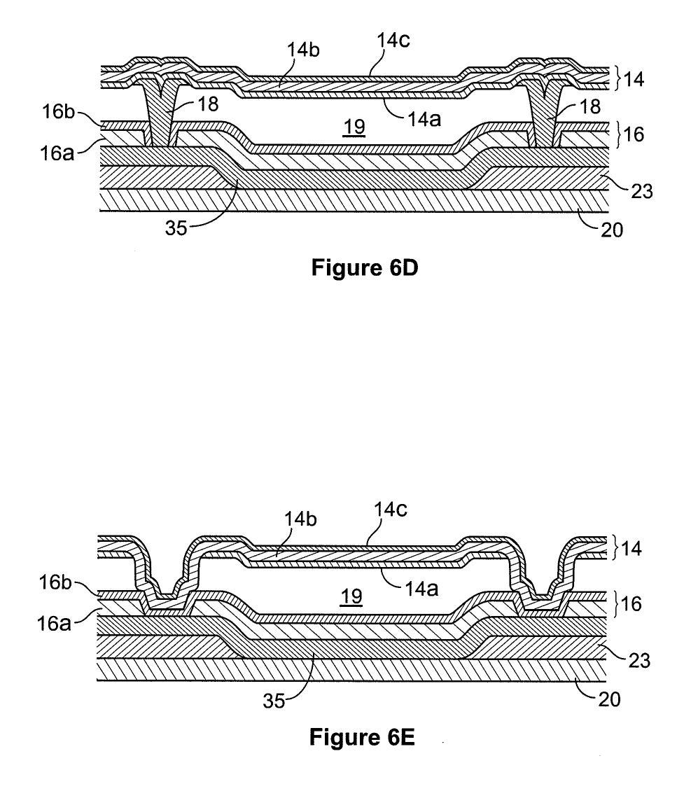

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a silicon dioxide (SiO₂) layer, and an aluminum alloy that serves as a reflector and a bussing layer, with a thickness in the range of about 30-80 Å, 500-1000 ÅA, and 500-6000 Å, respectively. The one or more layers can be patterned using a variety of techniques, including photolithography and dry etching, including, for example, tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

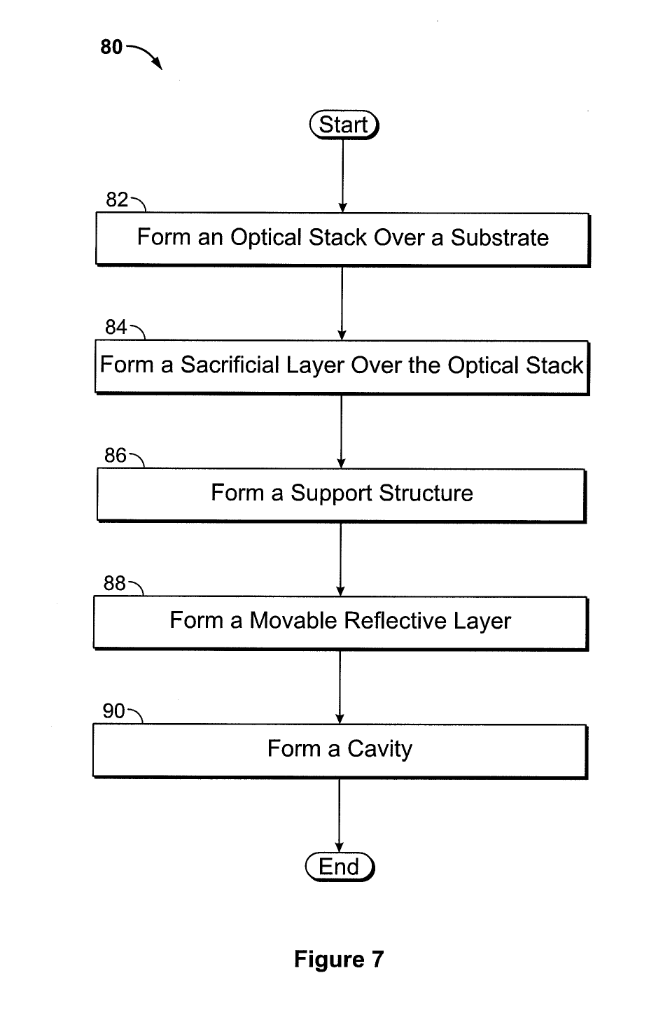

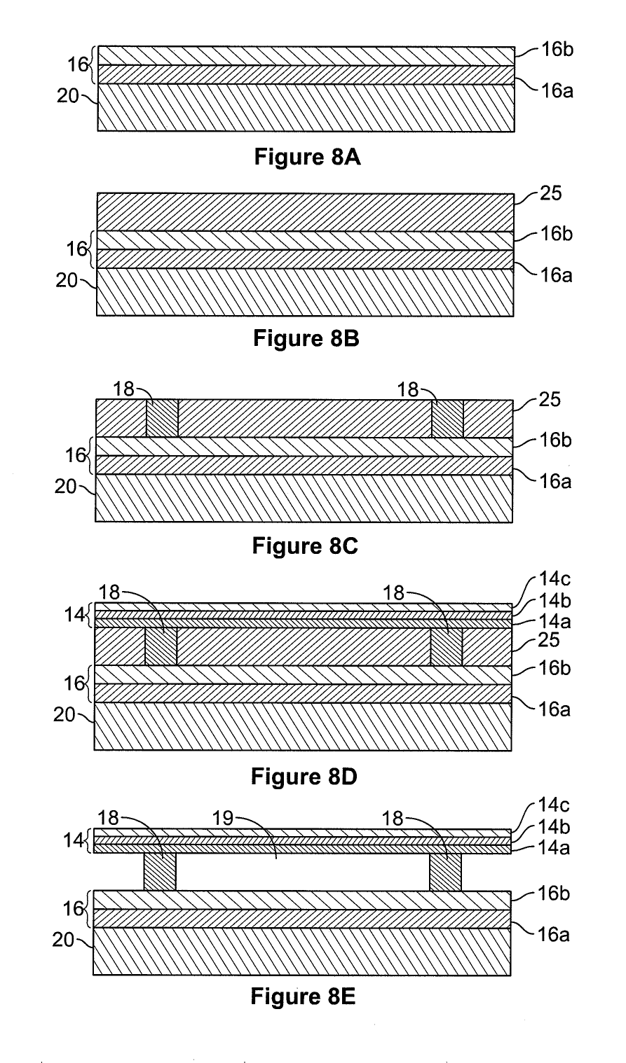

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In the implementation illustrated in FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as molybdenum (Mo) or amorphous silicon (Si) may be removed by dry chemical etching, e.g., by exposing the sacrificial layer 25 to a gaseous or vaporous etchant, such as vapors derived from solid xenon difluoride (XeF₂) for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Controlling the curvature of the movable reflective layer 14, or mechanical layer, in the relaxed position is desirable. For example, it can be desirable for the interferometric device in the relaxed state to be substantially flat when under bias, so as to improve the optical properties of the device. Additionally, controlling the launch height of the mechanical layer when the mechanical layer is released is also desirable. Although a bias voltage can be applied between the mechanical layer and the optical stack to aid in flattening the mechanical layer, the mechanical layer may remain displaced away from the substrate by a distance equal to about the thickness of the sacrificial layer plus the launch height even after application of bias. In an interferometric modulator (IMOD) implementation, a gap height can correspond to a particular reflected color. Thus, controlling the launch height upon release such that the sacrificial layer thickness needed for a particular gap size meets fabrication and optical performance standpoints is also desirable.

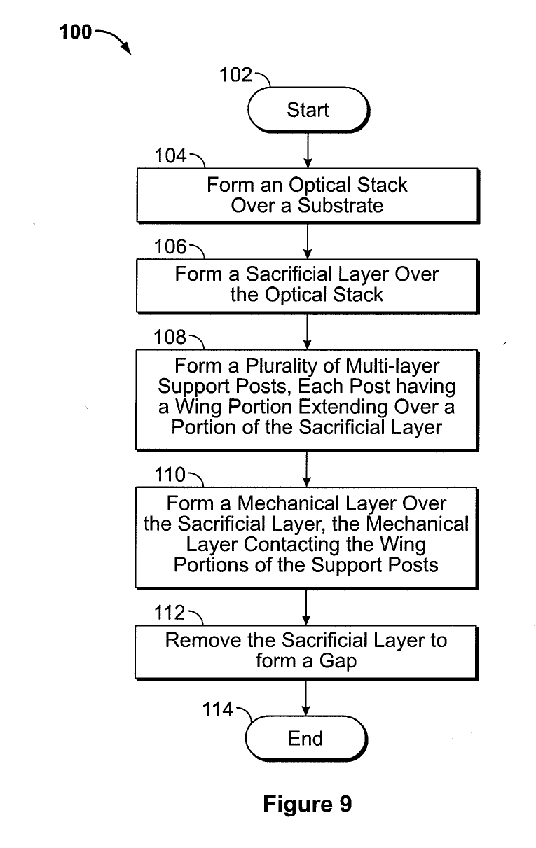

FIG. 9 shows an example of a flow diagram illustrating a manufacturing process 100 for an interferometric modulator.

The process 100 starts at 102. In block 104, a stationary electrode, such as an optical stack, is formed over a substrate. The substrate can be, for example, a transparent substrate including glass or plastic. Although the process 100 is illustrated as starting at block 102, the substrate can be subjected to one or more prior preparation steps such as, for example, a cleaning step to facilitate efficient formation of the optical stack. Additionally, in some implementations, one or more layers are provided before forming the optical stack over the substrate. For example, a black mask can be provided before forming the optical stack.

As discussed above, the optical stack of an interferometric modulator can be electrically conductive, partially transparent and partially reflective, and can be fabricated, for example, by depositing one or more of the layers onto the transparent substrate. In some implementations, the layers are patterned into parallel strips, and may form row electrodes in a display device. As used herein, and as will be understood by a person having ordinary skill in the art, the term “patterned” is used herein to refer to masking as well as etching processes. In some implementations, the optical stack includes an insulating or dielectric layer covering conductive layer(s).

The process 100 illustrated in FIG. 9 continues at block 106, in which a sacrificial layer is formed over the optical stack. The sacrificial layer is later removed to form a gap, as will be discussed below. The formation of the sacrificial layer over the optical stack may include deposition of a fluorine-etchable material such as molybdenum (Mo) or amorphous silicon (Si), in a thickness selected to provide, after subsequent removal, a gap having the desired size. Multiple sacrificial layers can be deposited to achieve a plurality of gap sizes. For example, for an IMOD array, each gap size can represent a different reflected color.

The process 100 illustrated in FIG. 9 continues at block 108 with the formation of multi-layer support posts. Each support post can include a wing portion extending over a portion of the sacrificial layer. The formation of multi-layer support posts may include the steps of patterning the sacrificial layer to form a support structure aperture, then depositing a material (e.g., a silicon oxide) into the aperture using a deposition method such as PECVD, thermal CVD, or spin-coating. In some implementations, the support structure aperture formed in the sacrificial layer extends through both the sacrificial layer and the optical stack to the underlying substrate or black mask, so that the lower end of the support post contacts the substrate or black mask. In some other implementations, the aperture formed in the sacrificial layer extends through the sacrificial layer, but not through the optical stack.

The multi-layer post structure can control the launch and curvature of the mechanical layer when the mechanical layer is in the relaxed position, as will be described in detail below.

The process 100 illustrated in FIG. 9 continues at block 110 with the formation of a mechanical layer, such as the mechanical layer 14 illustrated in FIG. 6D. The mechanical layer can contact the wing portions of the multi-layer support posts formed in the block 108. The mechanical layer can be formed by employing one or more deposition steps, e.g., reflective layer (e.g., aluminum, aluminum alloy) deposition, along with one or more patterning, masking, and/or etching steps. Since the sacrificial layer is still present in the partially fabricated interferometric modulator formed at block 110, the mechanical layer is typically not moveable at this stage. A partially fabricated interferometric modulator that contains a sacrificial layer may be referred to herein as an “unreleased” interferometric modulator.

The process 100 illustrated in FIG. 9 continues at block 112 with the formation of a cavity or gap. The gap may be formed by exposing the sacrificial material, such as the sacrificial material deposited at the block 106, to an etchant. For example, an etchable sacrificial material such as molybdenum (Mo), tungsten (W), tantalum (Ta) or polycrystalline or amorphous silicon (Si) may be removed by dry chemical etching, for example, by exposing the sacrificial layer to a fluorine-based gaseous or vaporous etchant, such as vapors derived from solid xenon difluoride (XeF₂). As skilled artisans will recognize, the sacrificial layer can be exposed for a period of time that is effective to remove the material, typically selectively relative to the structures surrounding the gap. Other selective etching methods, for example, wet etching and/or plasma etching, also can be used. Since the sacrificial layer is removed during block 112 of the process 100, the mechanical layer is released at this stage, and can become displaced away from the substrate by a launch height due to mechanical stresses. Additionally, the mechanical layer can change shape or curvature at this point. The resulting fully or partially fabricated interferometric modulator may be referred to herein as a “released” or “launched” interferometric modulator.

As described above, each multi-layer post structure can include a multi-layer wing for supporting the mechanical layer over the substrate to define the gap. The launch of the mechanical layer can be controlled by selecting, for example, the materials, thicknesses, stresses and/or geometries of the layers of the multi-layer wing to achieve a desired launch. Before removal of the sacrificial layer, the sacrificial layer can provide a counterforce that can prevent the wing from deflecting under the influence of residual stresses, such as residual stresses in the multi-layer wing and/or residual stresses in one or more sub-layers of the mechanical layer. However, upon release of the sacrificial layer, the stress-induced forces of the wing and mechanical layer can cause the wing to become deflected relative to the substrate, thereby influencing the launch and curvature of the mechanical layer. For example, if an uppermost layer and a lowermost layer of a multi-layer wing each have a compressive stress that is higher as compared to a stress of an intermediate layer, selecting a thickness of the uppermost layer to be less than a thickness of the lowermost layer can cause the multi-layer wing to deflect upwards, thereby increasing the launch and curvature of the mechanical layer. Conversely, when the uppermost layer and the lowermost layer of the multi-layer wing each have a compressive stress that is higher as compared to a stress of the intermediate layer, selecting a thickness of the uppermost layer to be greater than a thickness of the lowermost layer can cause the multi-layer wing to deflect downwards, thereby reducing the launch and curvature of the mechanical layer. Other characteristics of the multi-layer wing, such as a stress characteristic, can also be selected to tune the launch and curvature of a mechanical layer. For example, if a compressive stress of the uppermost layer is lower than a compressive stress of the lowermost layer, the multi-layer wing can deflect upwards, thereby increasing the launch and curvature of the mechanical layer. Similarly, if the compressive stress of the uppermost layer is higher than the compressive stress of the lowermost layer, the multi-layer wing can deflect downwards, thereby reducing the launch and curvature of the mechanical layer.

In some implementations, the multi-layer post has a first layer, a second layer, and a third layer, and the second layer is positioned between the first and third layers, which include substantially the same composition. By creating a symmetric structure in which the first and third layers are substantially the same material, the first and third layers can have balanced stresses when of equal thicknesses and otherwise processed in substantially the same manner. Thus, a thickness and/or any other suitable property of the first layer can be changed relative to the third layer to create a stress imbalance between the first and third layers. The stress imbalance can be employed to provide relatively fine-tuned control of mechanical layer launch. Additionally, providing a symmetric multi-layer wing structure can reduce variation in gap height across temperature. For example, a symmetric multi-layer wing can exhibit less variation in gap height across temperature than an asymmetric wing, since an asymmetric wing can exhibit bending variation across temperature due to differences in thermal coefficients of expansion between the layers.

The multi-layer post can serve additional functions. For example, the multi-layer post can include a first layer in physical contact with the sacrificial layer before release. The first layer can be configured to be resistant to the processing chemistry used to release the mechanical layer. Thus, the first layer can both serve to tune the launch and resulting curvature of the mechanical layer and to protect the post from damage during the release process. For a xenon difluoride (XeF₂) release process, the first layer can be, for example, silicon dioxide (SiO₂), alumina (Al₂O₃) or any other material resistant to a xenon difluoride (XeF₂) etch. However, when using different sacrificial release chemistries, the first layer can include other materials.

The process 100 illustrated in FIG. 9 ends at 114. The skilled artisan will readily appreciate that many additional steps may be employed before, in the middle of, or after the illustrated sequence, but are omitted for simplicity.

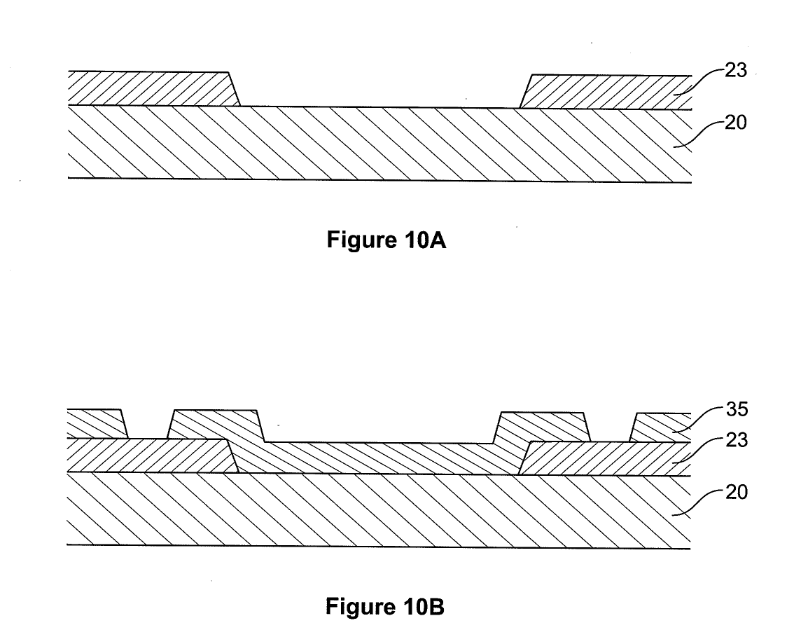

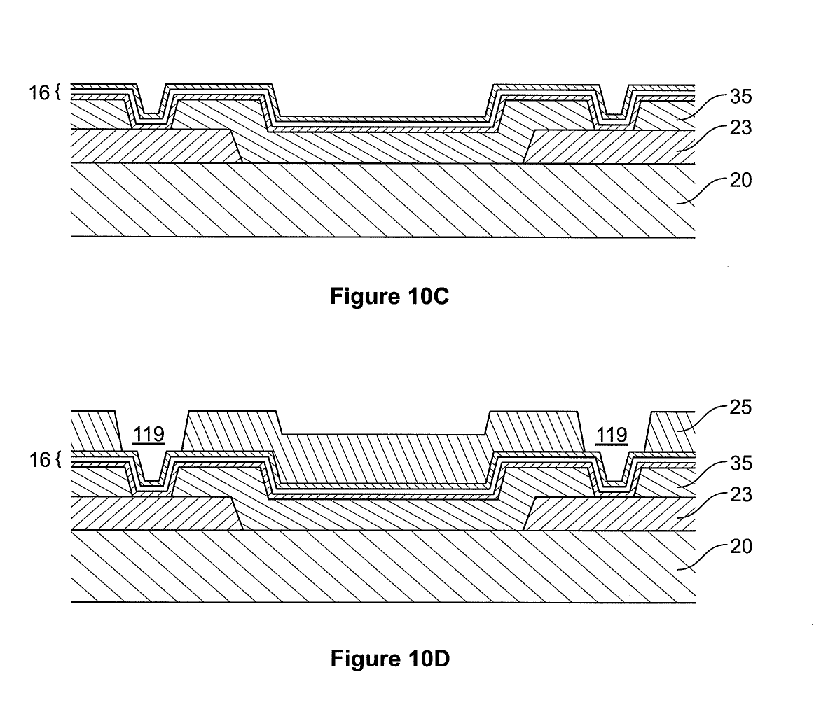

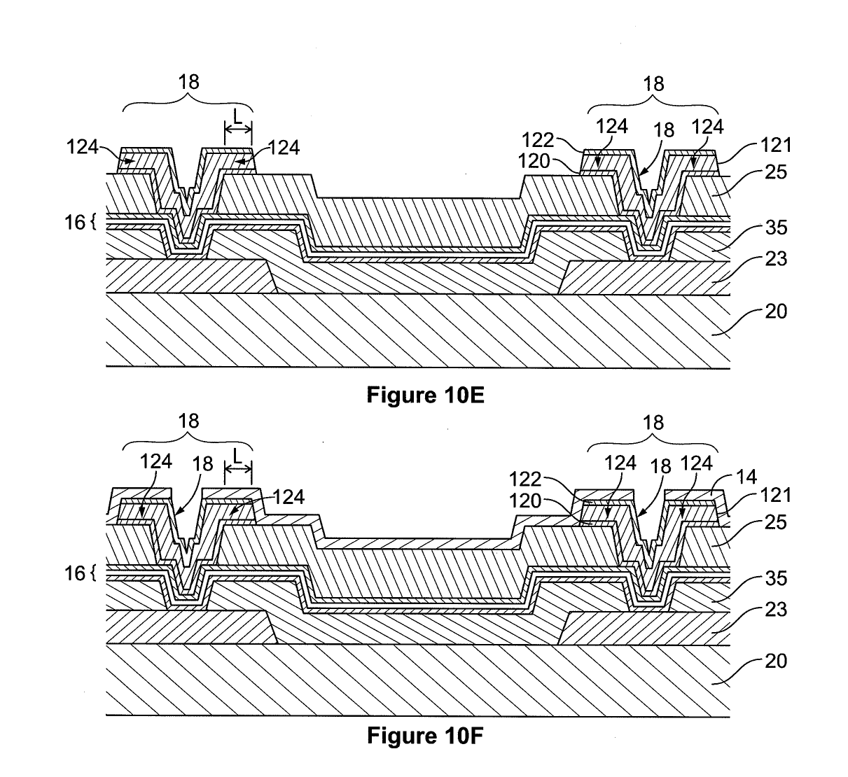

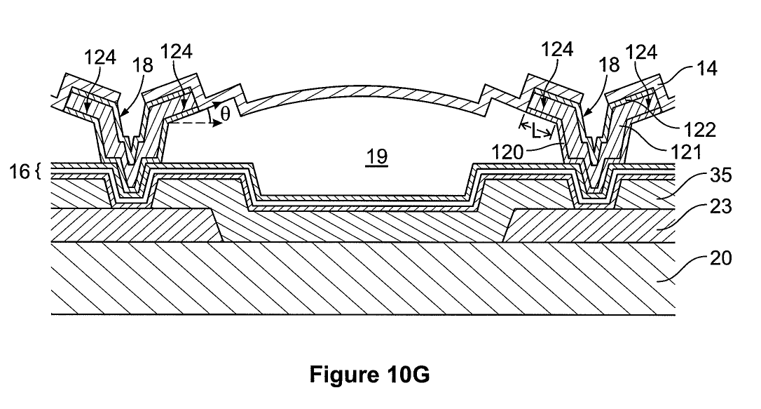

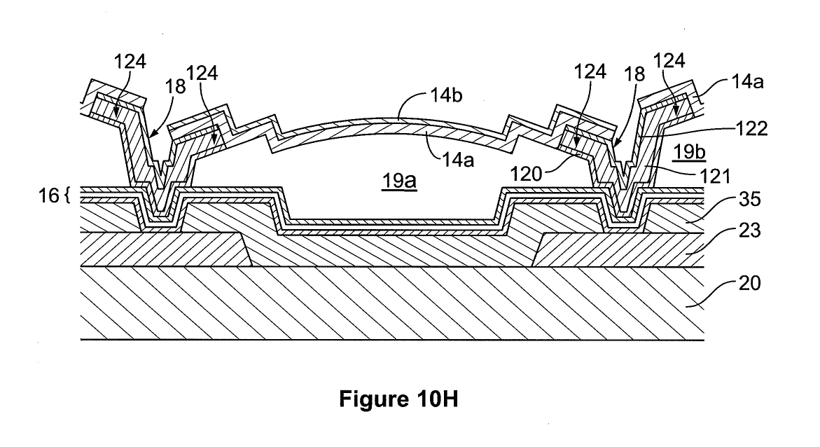

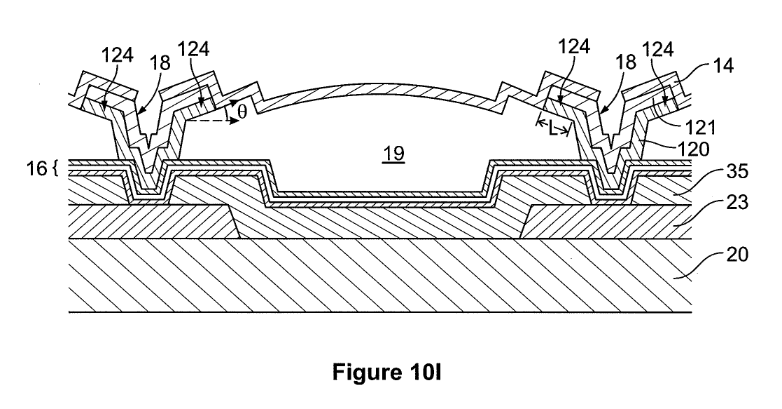

FIGS. 10A-10I show examples of cross-sectional schematic illustrations of various stages in a method of making manufacturing processes for interferometric modulators according to various implementations. While particular parts and steps are described as suitable for interferometric modulator implementations, a person having ordinary skill in the art will readily understand that for other electromechanical systems implementations, or microelectromechanical systems implementations, different materials can be used or parts modified, omitted, or added.

In FIG. 10A, a black mask structure 23 has been provided and patterned on a substrate 20. The substrate 20 can include a variety of materials, including glass, plastic or any transparent polymeric material which permits images to be viewed through the substrate 20. The black mask structure 23 can be configured to absorb ambient or stray light in optically inactive regions (e.g., beneath supports or between pixels) to improve the optical properties of a display device by increasing the contrast ratio. Additionally, the black mask structure 23 can be conductive and configured to function as an electrical bussing layer.

The black mask structure 23 can be formed using a variety of methods, including deposition and patterning techniques as described above with reference to FIG. 9. The black mask structure 23 can include one or more layers which can be patterned using a variety of techniques, including photolithography and a dry etch

Although FIGS. 10A-10G are shown as including the black mask structure 23, persons having ordinary skill in the art will recognize that this is for illustrative purposes only, and that the methods of controlling curvature and shaping a mechanical layer as described herein can be equally applicable to processes lacking the black mask structure 23.

FIG. 10B illustrates providing and patterning a spacer or dielectric structure 35. The dielectric structure 35 can include, for example, silicon oxynitride (SiON) and/or another dielectric material such as a silicon nitride or silicon oxide. In some implementations, the thickness of the dielectric structure 35 is in the range of about 3000-5000 Å. However, the dielectric structure 35 can have a variety of thicknesses depending on the desired optical properties. In some implementations, the dielectric structure 35 can be removed over a portion above the black mask structure 23, such as to permit routing and row electrode layers to reach the black mask structure 23, such as in implementations in which the black mask structure 23 serves to bus signals.

FIG. 10C illustrates providing and patterning an optical stack 16 over the dielectric structure 35. As described above, the optical stack 16 can include several layers, including, for example, a transparent conductor, such as indium tin oxide (ITO), a partially reflective optical absorber layer, such as chromium, and a transparent dielectric. The optical stack 16 can thus be electrically conductive, partially transparent and partially reflective. As illustrated in FIG. 10C, one or more layers of the optical stack 16 may physically and electrically contact the black mask structure 23.

FIG. 10D illustrates providing and patterning a sacrificial layer 25 over the optical stack 16. The sacrificial layer 25 is typically later removed to form a gap. The formation of the sacrificial layer 25 over the optical stack 16 can include a deposition step, as described above with reference to FIG. 9. Additionally, the sacrificial layer 25 can be selected to include more than one layer, or include a layer of varying thickness, to aid in the formation of a display device having a multitude of resonant optical gaps. For an IMOD array, each gap size can represent a different reflected color. Moreover, in some implementations, multiple layers of different functions can be provided, over or between sacrificial layers. As illustrated in FIG. 10D, the sacrificial layer 25 may be patterned over the black mask structure 23 to form support post apertures 119, which can aid in the formation of multi-layer support posts, as will be described below.

Reference will now be made to FIGS. 10E and 10F. FIG. 10E illustrates providing and patterning a first support layer 120, a second support layer 121, and a third support layer 122 to form multi-layer support posts 18. FIG. 10F illustrates providing and patterning a mechanical layer 14 over the sacrificial layer 25 and the multi-layer support posts 18.

As illustrated, each multi-layer support post 18 can include at least one wing 124. Each wing 124 can contact the mechanical layer 14, and can be used to support the mechanical layer 14 over the substrate 20 after removal of the sacrificial layer 25. The wing 124 and the sacrificial layer 25 can overlap by a length L.

The wing 124 of the post structure can be configured to have a net mechanical stress such that the wing 124 bends relative to the substrate 20 when the mechanical layer 14 is released, i.e., by removing the sacrificial layer 25. In some implementations, the overlap L of the wing 124 over the sacrificial layer 25 (or the gap after release) is selected to control the launch height. For example, when the wing 124 is configured to bend upward upon release, increasing the wing length L will increase launch. The launch increase can be caused by a variety of factors. For example, as the wing length L increases, the stress difference can exert increasing force that can bend the wing up to a greater extent. Additionally, longer wing lengths can have greater vertical displacement at the wing tip. In some implementations, the wing length L is selected to be in the range of about 1 micron to about 3 microns.

Each wing 124 can include a plurality of layers, such as a first support layer 120, a second support layer 121, and a third support layer 122. Although the wing 124 is illustrated for the case of three layers, more or fewer layers can be employed.

The launch of the mechanical layer 14 can be controlled by selecting, for example, the materials, thicknesses, stresses and/or geometries of the first, second, and third support layers 120-122 to achieve a desired launch. For example, the second support layer 121 can be configured to have a tensile stress, and the first and third support layers 120, 122 can be configured to have a compressive stress, and the relative thicknesses of the first, second and third support layers 120-122 can be selected to tune the launch of the mechanical layer 14, thereby increasing or decreasing the launch and curvature of the mechanical layer 14 to a desired degree. For instance, the selection of the thicknesses, stresses and/or geometries of the first, second, and third support layers 120-122 can affect the net internal stress of the wing. Upon removal of the sacrificial layer 25, the internal stresses can exert a force on the wing, thereby deflecting the wing and affecting the launch of the mechanical layer 14. As discussed above, in one implementation, the thickness of the third layer 122 is reduced and/or the third layer 122 is selected to have a compressive stress so as to increase the mechanical layer 14 launch and curvature.

In some implementations, the first and third support layers 120, 122 each have a thickness ranging, for example from about 100 Å to about 600 Å, and the second support layer 121 has a thickness ranging, for example, about 2000 Å to about 7000 Å.

In some implementations, the same material is selected for the first and third support layers 120, 122. For example, the first and third support layers 120, 122 can include silicon dioxide (SiO₂) and the second support layer 121 can include silicon oxynitride (SiON). Selecting the same material for the first and third support layers 120, 122 can result in a wing 124 having balanced stresses when the first and third support layers 120, 122 are of substantially equal thicknesses and otherwise fabricated in a similar manner. Thus, varying a thickness or any other suitable characteristic of the first support layer 120 relative to that of the third support layer 122 can provide relatively fine-tuned control over launch and/or curvature. Employing a symmetric structure in this manner avoids a need to fabricate first and third support layers having an absolute stress of a particular value, which can be difficult to accomplish from device to device due to a variety of factors, such as process variation. Thus, varying a thickness or any other suitable characteristic of the first support layer 120 relative to that of the third support layer 122 can provide a relative difference in stress that can be used to provide fine-tuned control over the launch and/or curvature of the mechanical layer 14.

The stresses of the first, second, and third support layers 120-122 can be controlled by choice of material and/or any suitable processing technique. For example, certain materials, including, for example silicon dioxide (SiO₂) and aluminum (Al), can have a compressive stress, while certain other materials, including, for example, silicon oxynitride (SiON) and silicon nitride (SiNₓ), can have either tensile or compressive stress. Furthermore, controlling certain processing parameters, including, for example, plasma power, pressure, process gas composition, plasma gas ratio, and/or temperature, the stress of a layer can be controlled.

In some implementations, the first and third support layers 120, 122 have stresses of a first type, and the second support layer 121 has a stress of an opposite type. For example, the first and third support layers 120, 122 can have a compressive stress, and the second support layer 121 can have a tensile stress. Providing first and third support layers 120, 122 having opposite stresses from the second support layer 121 can aid in obtaining fine-tuned control over the net stress of the wing 124. For example, the first, second and third support layers 120-122 can be configured such that the net stress of the wing 124 is in the range of about −50 MPa to about +50 MPa. In some implementations, the stress of the first support layer 120 is selected to be in the range of about −300 MPa to about 0 MPa, the stress of the second support layer 121 is selected to be in the range of about 0 MPa to about +200 MPa, and the stress of the third support layer 122 is selected to be in the range of about −300 MPa to about 0 MPa. Persons having ordinary skill in the art will appreciate that positive stresses can be tensile stresses and negative stresses can be compressive stresses.

The mechanical layer 14 can include any suitable materials, including for example, silicon oxynitride (SiON). Although the mechanical layer 14 is illustrated as having a single layer, additional layers can be utilized. One such implementation of a multi-layer mechanical layer is described below with reference to FIG. 10H. In some implementations, the mechanical layer 14 has a thickness ranging between about 1,000 Å to about 1 micron.

FIG. 10G illustrates the interferometric device after removal of the sacrificial layer 25 of FIG. 10F to form a gap 19. The sacrificial layer 25 may be removed at this point using a variety of methods, as described above with reference to FIG. 9. After release, the mechanical layer 14 can become displaced away from the substrate 20 by a launch height and can change shape or curvature at this point. By selecting the characteristics of the first, second and third support layers 120-122 of the wing 124, the deflection of the wing 124 can be controlled relative to the substrate 20, thereby controlling the launch and curvature of the mechanical layer 14 after release. The deflection of the wing 124 can have an angle 0 relative to the substrate 20. In some implementations, the deflection of the wing 124 is controlled such that the angle 0 is in the estimated range of about 0° to about 5°.

In certain applications, pixel launch can be desirable. For example, in an interferometric modulator, selecting launch to be in the range of about 500 Å to about 1000 Å away from the substrate 20 can reduce pixel stiction between the mechanical layer 14 and the optical stack 16. However, a relatively large pixel launch can increase the portion of the mechanical layer 14 out of contact with the optical stack 16 during actuation, and thus can degrade the dark state of the device. Thus, employing the multi-layer wing 124 to control the launch of the mechanical layer 14 can be used to reduce pixel stiction and improve the dark state of an interferometric modulator.

The first, second, and third support layers 120-122 can perform functions in addition to that of launch and/or curvature control. For example, the first support layer 120 can be configured to be resistant to the processing chemistry used to release the mechanical layer. Thus, the first support layer 120 can both serve to tune the launch and resulting curvature of the mechanical layer and to protect the post from damage during the release process. For a xenon difluoride (XeF₂) release process for the sacrificial layer 25, the first support layer 120 can be, for example, silicon dioxide (SiO₂), alumina (Al₂O₃) or any other material resistant to a XeF₂ etch. However, when using different sacrificial release chemistries, the first support layer 120 can include other materials. Employing the first support layer 120 as a sacrificial release protection layer can increase design flexibility of the support post 18 by permitting the use of a wide range of materials that may otherwise be unavailable. For example, when using a XeF₂ release process, the second support layer 121 can include silicon oxynitride (SiON) or any other material that could otherwise be damaged by a XeF₂ release process.

Although FIG. 10G illustrates an implementation in which the first, second, and third support layers 120-122 each overlap the gap 19 by substantially the same length L. In some implementations, the first, second and third support layers 120-122 can each overlap the gap 19 by different lengths. For example, the first and third support layers 120, 122 can overlap the gap 19 by a length greater than the overlap of the second support layer 121 and the gap 19.

FIG. 10H illustrates an interferometric device according to another implementation. The interferometric device of FIG. 10H is similar to the interferometric device of FIG. 10G, except the interferometric device of FIG. 10H includes a plurality of gap heights and a mechanical layer 14 having a plurality of layers.

In a color interferometric display system, multiple interferometric cavities may have different gap sizes to interferometrically enhance, for example, the colors red, green, and blue. Thus, as shown in FIG. 10H, the interferometric device can include a first gap 19a and a second gap 19b of different heights. In order to permit the same actuation voltage to collapse the mechanical layer 14 for each gap size, the mechanical layer 14 can include different materials, number of layers, or thicknesses over each gap. Thus, as shown in FIG. 10H, a portion of the mechanical layer 14 over the first gap 19a can include a first layer 14a and a second layer 14b, while a portion of the mechanical layer 14 over the second gap 19b can include only the first layer 14a.

As shown in FIG. 10H, a multi-layer post 18 can be used in implementations in which the interferometric device includes a plurality of gap heights, or in which the mechanical layer 14 has varying materials, number of layers, or thicknesses at different portions of the mechanical layer 14.

FIG. 10I illustrates an interferometric device according to another implementation. The interferometric device of FIG. 10I is similar to the interferometric device of FIG. 10G, except the interferometric device of FIG. 10I includes a multi-layer post 18 having two layers. The launch of the mechanical layer 14 can be controlled by selecting, for example, the materials, thicknesses, stresses and/or geometries of the first and second support layers 120, 121 in a manner similar to that described above. The interferometric device of FIG. 10I can include less processing steps that the interferometric modulator of FIG. 10G, and thus may have less manufacturing cost. In some implementations, the multi-layer wing can be asymmetric, and thus can have increased variation in gap height across temperature relative to a symmetric structure. Such implementations can include, for example, implementations where the first and second support layers 120, 121 are materials of a different composition. For example, a two layer wing employing support layers of a different composition of materials can exhibit relatively high variation in gap height across temperature relative to a symmetric structure due to differences in thermal coefficients of expansion between the materials.

In some two-layer wing implementations, the first and second support layers 120, 121 have stresses such that the net stress of the wing 124 is in the range of about −50 MPa to about +50 MPa. In some implementations, the stress of the first support layer 120 is selected to be in the range of about −300 to about 0 MPa, and the stress of the second support layer 121 is selected to be in the range of about 0 MPa to about +200 MPa.

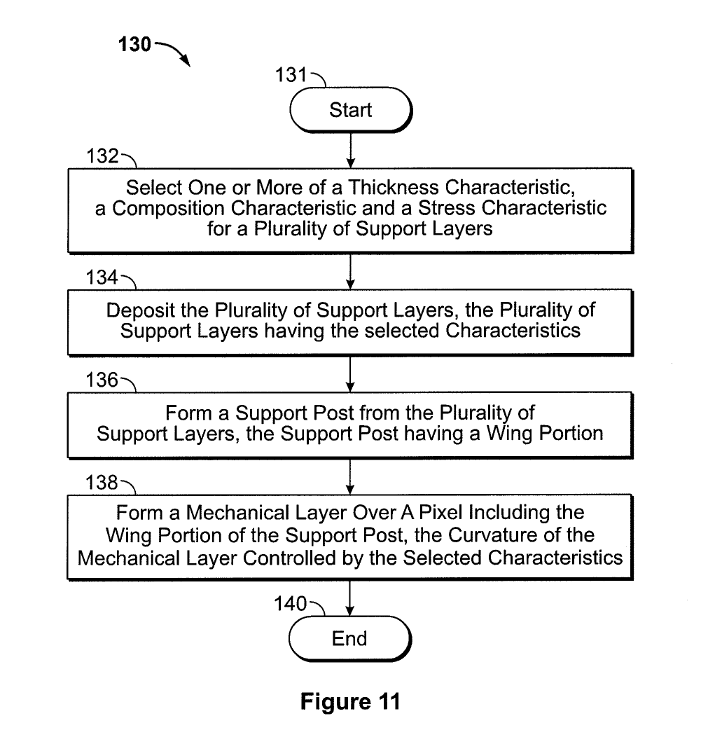

FIG. 11 shows an example of a flow diagram illustrating a method 130 of controlling the curvature of a mechanical layer. The method 130 starts at block 131. In block 132, one or more of a thickness characteristic, a composition characteristic, and a stress characteristic for a plurality of support layers is selected. As will be described below, the plurality of support layers can be subsequently deposited having the selected characteristics, and the support layers can be used to form multi-layer wings for supporting a mechanical layer. The multi-layer wings can have a deflection controlled by the characteristics selected in block 132.

The plurality of support layers can have a total thickness selected to achieve the desired structural rigidity for the wing. The plurality of support layers can include a first layer, a second layer, and a third layer, and a thickness of the first support layer can be selected relative to the thickness of the third support layer to create an asymmetry between the first and third support layers, which can create a mechanical stress for deflecting the wing upon removal of a sacrificial layer.

A composition characteristic of the plurality of support layers also can be used to control the deflection of the multi-layer wings. For example, the plurality of support layers can include a first layer, a second layer, and a third layer, and the first and third support layers can include silicon dioxide (SiO₂), and the second support layer can include silicon oxynitride (SiON). Since SiO₂ can have a compressive stress and SiON can have a tensile stress (or near zero stress), selection of the materials for the first, second and third support layers can influence the deflection of the multi-layer wings. For example, if the third layer has a reduced thickness and/or stress relative to the first layer, the wing will deflect upwards, thereby increasing the mechanical layer launch and curvature. Conversely, if the third layer has an increased thickness and/or stress relative to the first layer, the wing will deflect downwards, thereby reducing the mechanical layer launch and curvature.

Additionally, a composition difference between a mechanical layer and a layer of the multi-layer wing in contact with the mechanical layer can create a residual stress that can influence the launch of the mechanical layer when a sacrificial layer is removed. The composition characteristic of the first, second, and third support layers can be selected to serve additional functions besides curvature control. For example, as was described above, the first support layer can be in contact with a sacrificial layer, and can be selected to have a resistance to a release chemistry of the sacrificial layer.

The method 130 continues at a block 134, in which the plurality of support layers are deposited having the characteristics selected in block 132. In block 136, a support post is formed from the plurality of support layers, and the support post includes a wing portion. As was described earlier, an aperture for a post can be formed in a sacrificial layer, and a plurality of support layers can be formed over the sacrificial layer and aperture using any suitable technique, including, for example, deposition. The plurality of support layers can be patterned to form multi-layer support posts. A portion of the support post can overlap the sacrificial layer to form a wing. Additional details of the block 134 can be as described above with reference to FIG. 10E.

In block 138, a mechanical layer is formed as part of an upper structure of the pixel, including the wing portion of the support post. Upon release of the mechanical layer, the wing of the support post can become deflected relative to the substrate and the curvature of the mechanical layer can be controlled based upon the characteristics selected for the plurality of support layers in block 132. The method 130 ends at 140.

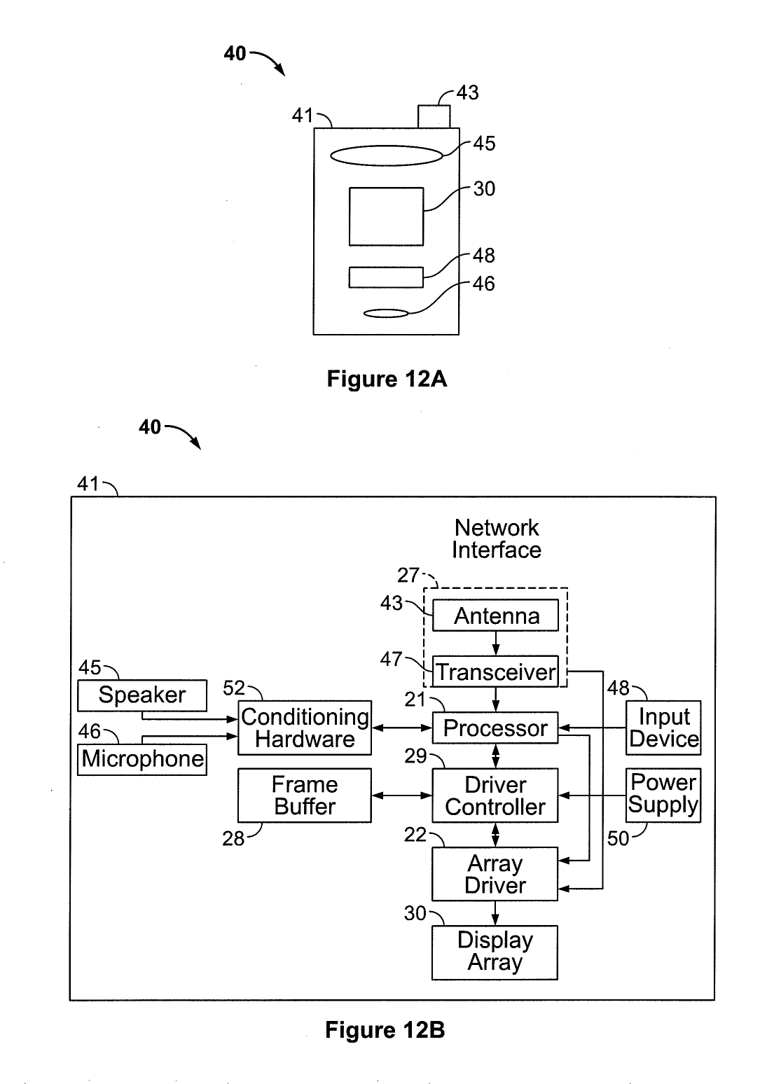

FIGS. 12A and 12B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array. driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems device, comprising:
a substrate;
a mechanical layer positioned over the substrate, the mechanical layer spaced from the substrate and defining one side of a gap between the mechanical layer and the substrate, wherein the mechanical layer is movable in the gap between an actuated position and a relaxed position; and
a post positioned on the substrate supporting the mechanical layer, the post having a wing portion in contact with a portion of the mechanical layer, wherein the wing portion is positioned between a portion of the gap and the mechanical layer,
wherein the wing portion of the post includes a plurality of layers configured to control the curvature of the mechanical layer.

2. The electromechanical systems device of claim 1, wherein the plurality of layers includes a first layer, a second layer, and a third layer, the second layer disposed between the first and third layers.

3. The electromechanical systems device of claim 2, wherein the first layer, the second layer and the third layer have a first thickness, a second thickness and a third thickness, respectively, and wherein the first, second and third thicknesses are selected so as to control the curvature of the mechanical layer.

4. The electromechanical systems device of claim 3, wherein the first layer has a thickness ranging between about 100 Å to about 2,000 Å, the second layer has a thickness ranging between about 2,000 Å to about 10,000 Å, and the third layer has a thickness ranging between about 100 Å to about 2,000 Å.

5. The electromechanical systems device of claim 2, wherein the first layer and the third layer include a first material and the second layer includes a second material, wherein the second material is different than the first material.

6. The electromechanical systems device of claim 5, wherein the first material includes SiO₂ and the second material includes SiON.

7. The electromechanical systems device of claim 2, wherein the first layer, second layer and third layer are configured to have a first stress, a second stress and a third stress, respectively, and wherein the stresses of the first, second, and third layers are selected so as to control the curvature of the mechanical layer.

8. The electromechanical systems device of claim 7, wherein the stresses of the first and third layers are compressive, and wherein the stress of the second layer is tensile.

9. The electromechanical systems device of claim 7, wherein the first stress is selected to be in the range of about −300 MPa to about 0 MPa, the second stress is selected to be in the range of about 0 MPa to about +200 MPa, and the third stress is selected to be in the range of about −300 MPa to about 0 MPa.

10. The electromechanical systems device of claim 2, wherein the first layer is disposed between the second layer and the gap, and wherein the first layer is resistant to a sacrificial release etch chemistry of the mechanical layer.

11. The electromechanical systems device of claim 10, wherein the sacrificial release etch chemistry is a Fluorine-based chemistry.

12. The electromechanical systems device of claim 2, wherein the curvature of the mechanical layer is controlled so that the mechanical layer curves away from the substrate when in the relaxed position.

13. The electromechanical systems device of claim 2, further comprising a stationary electrode positioned between the substrate and the gap.

14. The electromechanical systems device of claim 13, wherein the stationary electrode is an optical stack, and wherein the mechanical layer further includes a bottom reflective surface facing the gap, and wherein the optical stack and the bottom reflective surface of the mechanical layer form an interferometric modulator.

15. The electromechanical systems device of claim 14 further comprising a bias circuit configured to apply a bias voltage, wherein when the bias voltage is applied at least a portion of the mechanical layer is substantially parallel to the substrate.

16. The electromechanical systems device of claim 1, further comprising:
a display;
a processor that is configured to communicate with the display, the processor being configured to process image data; and
a memory device that is configured to communicate with the processor.

17. The electromechanical systems device of claim 16, further comprising a driver circuit configured to send at least one signal to the display.

18. The electromechanical systems device of claim 17, further comprising a controller configured to send at least a portion of the image data to the driver circuit.

19. The electromechanical systems device of claim 18, further comprising an image source module configured to send the image data to the processor.

20. A method of controlling the curvature of a mechanical layer in an electromechanical systems device, the mechanical layer having an actuated position and a relaxed position, the method comprising:
selecting one or more of a thickness characteristic, a composition characteristic, and a stress characteristics for each of a plurality of layers of a support post;
depositing support layers over a substrate, the support layers including the plurality of layers, the plurality of layers including the one or more selected thickness, composition, and stress characteristics;
forming a support post from the plurality of support layers, the support post including a wing portion; and
forming a mechanical layer spaced from the substrate and defining one side of a gap, wherein the mechanical layer is formed over the wing portion of the support post and in contact with the wing portion, and wherein the mechanical layer is formed to be movable between an actuated position and a relaxed position,
wherein a curvature of the mechanical layer when in the relaxed position is controlled by the selected one or more thickness, composition, and stress characteristics of the plurality of layers.

21. The method of claim 20, wherein a deflection of the wing portion relative to the substrate is controlled by the selected one or more thickness, composition, and stress characteristics.

22. The method of claim 20, wherein the support layers include a first layer, a second layer, and a third layer, the second layer disposed between the first and third layers.

23. The method of claim 22, further comprising providing a sacrificial layer over the substrate before forming the mechanical layer, and removing the sacrificial layer using an etchant to form the gap.

24. The method of claim 23, wherein at least a portion of the first layer is disposed between the second layer and the gap, and wherein the first layer is resistant to the etchant of the sacrificial layer.

25. The method of claim 22, wherein the wing portion overlaps the sacrificial layer, and wherein the curvature of the mechanical layer when in the relaxed position is further controlled by an overlap of the wing portion and the sacrificial layer.

26. The method of claim 22, wherein the curvature of the mechanical layer when in the relaxed position is controlled by the selected one or more thickness, composition, and stress characteristics so that the mechanical layer curves away from the substrate.

27. The method of claim 22, wherein selecting one or more of the thickness characteristic, the composition characteristic, and the stress characteristics for each of the plurality of layers of the support post includes selecting a thickness for the first layer, a thickness for the second layer, and a thickness for the third layer, wherein the curvature of the mechanical layer when in the relaxed position is controlled by the selected thicknesses of the first, second, and third layers.

28. The method of claim 22, wherein the first layer and third layers include silicon dioxide (SiO₂) and the second layer includes silicon oxynitride (SiON).

29. The method of claim 20, further comprising forming an optical stack over the substrate, wherein the optical stack, the mechanical layer and the gap form an interferometric cavity.

30. The method of claim 29 further comprising applying a bias voltage to the optical stack so that at least a portion of the mechanical layer is substantially parallel to the substrate.

31. An electromechanical systems device, comprising:
a substrate;
a mechanical layer positioned over the substrate, the mechanical layer spaced from the substrate and defining one side of a gap between the mechanical layer and the substrate, wherein the mechanical layer is movable in the gap between an actuated position and a relaxed position; and
means for supporting the mechanical layer positioned on the substrate, the supporting means including a means for directing a curvature of the mechanical layer, wherein the curvature directing means is in contact with a portion of the mechanical layer and positioned between a portion of the gap and the mechanical layer,
wherein the curvature directing means includes a plurality of layers configured to direct the curvature of the mechanical layer.

32. The electromechanical systems device of claim 31, wherein the curvature directing means includes a first layer, a second layer, and a third layer, the second layer disposed between the first and third layers.

33. The electromechanical systems device of claim 32, wherein the curvature directing means is configured to direct the curvature of the mechanical layer based at least partly on a thickness of the first layer, a thickness of the second layer, and a thickness of the third layer.

34. The electromechanical systems device of claim 32, wherein the first layer and the third layer include a first material and the second layer includes a second material, wherein the second material is different than the first material.

35. The electromechanical systems device of claim 32, wherein the curvature directing means is configured to direct the curvature of the mechanical layer based at least partly on a stress of the first layer, a stress of the second layer, and a stress of the third layer.

36. The electromechanical systems device of claim 32, wherein the first layer is disposed between the second layer and the gap, and wherein the first layer is resistant to a sacrificial release etch chemistry of the mechanical layer.

37. The electromechanical systems device of claim 32, wherein the curvature directing means is configured to direct the curvature of the mechanical layer means away from the substrate.

38. The electromechanical systems device of claim 32, further comprising an electrode positioned between the substrate and the gap.
